(19) United States
(12) Patent Application Publication
(10) Pub. No.: US 2026/0019237 A1
(43) Pub. Date: Jan. 15, 2026

(54) AUTHENTICATION DATA VALIDATION

(71) Applicant: Visa International Service Association, San Francisco, CA (US)

(72) Inventors: Henna Kapur, London (GB); Kevin Martin Walsh, Reading (GB); Adrian Portelli, London (GB); Bharatkumar Patel, London (GB); Hap Huynh, London (GB); Ranjiva Prasad, Hampshire (GB); Neil Hilton, London (GB)

(73) Assignee: Visa International Service Association, San Francisco, CA (US)

(21) Appl. No.: 18/995,699

(22) PCT Filed: Jul. 20, 2023
(86) PCT No.: PCT/US2023/070629

§ 371 Date: Jan. 16, 2025

Related U.S. Application Data
(60) Provisional application No. 63/391,060, filed on Jul. 21, 2022.

(51) Int. Cl. H04L 9/08; H04L 9/32

(52) U.S. Cl. CPC H04L 9/0825; H04L 9/3213; H04L 9/3247

(57) ABSTRACT

A server computer may receive an authentication data packet including authentication data from a relying party computer in communication with an authenticator associated with a user device. The server computer may verify the authentication data in the authentication data packet. The server computer may store the authentication data packet in a database. The server computer may transmit to an authorizing entity computer, a data packet including data relating to the verification of the authentication data.

### CROSS-REFERENCE TO RELATED APPLICATION(S)

This application is a PCT application claiming priority to U.S. Provisional Application No. 63/391,060, filed Jul. 21, 2022, which is incorporated by reference herein in its entirety.

### BACKGROUND

Users can utilize various credentials in order to gain access to a service or a product. However, the user credentials need to be authenticated so that any interaction of the user with resource provider is secure while the leakage of the sensitive information is avoided.

Currently, an authentication is performed by an authorizing entity such as an issuer to ensure that the transaction is valid and authentic. This may require sending challenges to the user attempting to perform the transaction, requiring the user to contact the issuer to confirm a transaction, etc. Such methods have drawbacks. For example, the authorizing entity needs to install complex authentication hardware and software to perform authentication. While this can be undertaken by large institutions with significant resources, it is more problematic for other institutions that may not have such resources. Further, current authentication processes may rely on the user providing a password or the like. Passwords can be obtained by illegitimate means such as hacking and social engineering, so password authentication by itself may not be entirely reliable.

Embodiments of the disclosure address the above-noted problems and other problems individually and collectively.

### SUMMARY

According to an aspect of an embodiment, a method is provided. A method includes: receiving, by a server computer, an authentication data packet including authentication data from a relying party computer in communication with an authenticator associated with a user device; verifying, by the server computer, the authentication data in the authentication data packet; storing, by the server computer, the authentication data packet in a database; and transmitting, by the server computer to an authorizing entity computer, a data packet including data relating to the verification of the authentication data.

According to an aspect of an embodiment, a server computer is provided. A server computer includes a processor; and a non-transitory computer readable medium including code that, when executed by the processor, causes the processor to perform a method including: receiving an authentication data packet including authentication data from a relying party computer in communication with an authenticator associated with a user device; verifying the authentication data in the authentication data packet; storing the authentication data packet in a database; and transmitting, to an authorizing entity computer, a data packet including data relating to the verification of the authentication data.

According to an aspect of an embodiment, a method is provided. A method includes: generating, by an authenticator associated with a user device, a public-private key pair; authenticating, by the authenticator, a user of the user device; generating, by the authenticator, a client data and an authenticator data, the authenticator data including an indication that the user has been authenticated by the authenticator; generating, by the authenticator, an assertion signature by signing a concatenated value with a private key of the public-private key pair, where the concatenated value is formed by concatenating the client data and the authenticator data; and sending, by the user device, a data packet including the client data, the authenticator data, and the assertion signature to a relying party computer, where the relying party computer validates the assertion signature using the received client data and authenticator data and a public key of the public-private key pair, and, based at least on the assertion signature being validated, generates an authentication data packet including an authentication data, the authentication data including the assertion signature, the client data, and the authenticator data, and sends the authentication data packet to a server computer, and where the server computer thereafter receives the authentication data packet, verifies the authentication data in the authentication data packet, stores the authentication data packet in a database, and transmits, to an authorizing entity computer, a data packet including data relating to the verification of the authentication data.

A better understanding of the nature and advantages of embodiments of the invention may be gained with reference to the following detailed description and accompanying drawings.

### BRIEF DESCRIPTION OF THE DRAWINGS

FIG. 1 shows a system and a swim-line flow diagram illustrating a method according to at least one embodiment.

FIG. 2 shows a system and a swim-line flow diagram illustrating a method according to at least one embodiment.

FIG. 3 shows a system and a swim-line flow diagram illustrating a method according to at least one embodiment.

FIG. 4 shows a system and a swim-line flow diagram illustrating a method according to at least one embodiment.

FIG. 5A shows a system and a swim-line flow diagram illustrating a method according to at least one embodiment.

FIG. 5B shows a system and a swim-line flow diagram illustrating a method according to at least one embodiment.

FIG. 6 shows a block diagram of a user device according to an embodiment.

### DETAILED DESCRIPTION

Prior to discussing embodiments of the disclosure, some terms can be described in further detail.

An “application” may be computer code or other data stored on a computer-readable medium (e.g. memory element or secure element) that may be executable by a processor to complete a task.

An “access device” may be any suitable device that provides access to a resource. An access device may be in any suitable form. Some examples of access devices include vending machines, kiosks, POS or point of sale devices (e.g., POS terminals), cellular phones, personal digital assistants (PDAs), personal computers (PCs), tablet PCs, hand-held specialized readers, set-top boxes, electronic cash registers (ECRs), automated teller machines (ATMs), virtual cash registers (VCRs), Web servers, and the like. An access device may use any suitable contact or contactless mode of operation to transmit or receive data from, or associated with, a user mobile communication device. In some embodiments, an access device may include a reader, a processor, and a computer-readable medium. A reader may include any suitable contact or contactless mode of operation. For example, exemplary readers can include radio frequency (RF) antennas, optical scanners, bar code readers, or magnetic stripe readers to interact with a payment device and/or mobile communication device.

“Access data” may include any suitable data that can be used to access a resource or generate data that can access a resource. In some embodiments, access data may be account information for a payment account. Account information may include a primary account number (PAN), payment token, expiration date, card verification values (e.g., CVV, CVV2), dynamic card verification values (dCVV, dCVV2), an identifier of an issuer with which an account is held, etc. In other embodiments, access data could include data that can be used to access a location or to access secure data. Such information may be ticket information for an event, data to access a building, transit ticket information, passwords, biometrics or other credentials to access secure data, etc.

An “authorizing entity” may be an entity that authorizes a request. Examples of an authorizing entity may be an issuer, a government agency, a document repository, an access administrator, etc. An authorizing entity may operate an authorizing entity computer.

An “issuer” may refer to a business entity (e.g., a bank) that issues and optionally maintains an account for a user. An issuer may also issue payment credentials to the consumer that may be stored on a user device.

A “processor” may refer to any suitable data computation device or

devices. A processor may include one or more microprocessors working together to accomplish a desired function. The processor may include a CPU including at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may include a non-transitory computer-readable medium that stores instructions that can be executed by a processor to implement a desired method. Examples of memories may include one or more memory chips, disk drives, etc. Such memories may operate using any suitable electrical, optical, and/or magnetic mode of operation.

A “mobile communication device” or a “mobile device” may include any suitable electronic device that may be transported and operated by a user, which may also optionally provide remote communication capabilities to a network. Examples of remote communication capabilities include using a mobile phone (wireless) network, wireless data network (e.g., 3G, 4G, 5G, or similar networks), Wi-Fi, Bluetooth, Bluetooth Low Energy (BLE), Wi-Max, or any other communication medium that may provide access to a network such as the Internet or a private network. Examples of mobile communication devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile communication device may include any suitable hardware and software for performing such functions, and may also include multiple devices or components (e.g., when a device has remote access to a network by tethering to another device—i.e., using the other device as a modem-both devices taken together may be considered a single mobile communication device).

A “user” may include an individual. In some embodiments, a user may be associated with one or more user devices.

A “user device” may be a device that is operated by a user. Examples of user devices may include a mobile phone or device, a smart phone, a card, a personal digital assistant (PDA), a laptop computer, a desktop computer, a server computer, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. Example of the input sensors may include accelerometers, cameras, microphones, etc. The user input obtained by the input sensors may be from a variety of data input types, including, but not limited to, audio data, visual data, or biometric data. The user device may include any electronic device that may be operated by a user, which may also provide remote communication capabilities to a network. Examples of remote communication capabilities include using a mobile phone (wireless) network, wireless data network (e.g., 3G, 4G, 5G or similar networks), Wi-Fi, Wi-Max, or any other communication medium that may provide access to a network such as the Internet or a private network.

A “resource provider” may be an entity that can provide a resource such as goods, services, information, and/or access to a location (e.g., a parking space, a transit terminal, etc.). Examples of resource providers include merchants, government authorities, secure data providers, etc. A resource provider may operate one or more access devices.

A “resource provider computer” can be a computer operated by a resource provider. An example of a resource provider computer can be an access device.

A “credential” may be any suitable information that serves as reliable evidence of worth, ownership, identity, or authority. A credential may be a string of numbers, letters, or any other suitable characters that may be present or contained in any object or document that can serve as confirmation.

A “value credential” may be information associated with worth. Examples of value credentials include payment credentials, coupon identifiers, information needed to obtain a promotional offer, etc.

“Payment credentials” may include any suitable information associated with an account (e.g., a payment account and/or payment device associated with the account). Such information may be directly related to the account or may be derived from information related to the account. Examples of account information may include a bank account number, PAN (primary account number or “account number”), username, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a username, an expiration date, a gift card number or code, and any other suitable information.

A “token” may be a substitute value for a credential. A token may be a string of numbers, letters, or any other suitable characters. Examples of tokens include access tokens such as payment tokens, data that can be used to access secure systems or locations, etc.

A “payment token” may include an identifier for a payment account that is a substitute for an account identifier, such as a bank account number, a primary account number (PAN), and/or an expiration date. For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., International Organization of Standardization (ISO) 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

An “authorization request message” may be a message that requests permission to conduct an interaction. For example, an authorization request message may include an electronic message that is sent to a payment processing network and/or an issuer associated with a payment credential to request authorization for a transaction. An authorization request message according to some embodiments may comply with ISO 8583, which is a standard for systems that exchange electronic transaction information associated with a payment made by a consumer using a payment device or payment account. The authorization request message may include a payment credential such as a PAN or primary account number, or a payment token. An authorization request message may also include additional data elements corresponding to “identification information” including, by way of example only: a service code, a CVV (card verification value), a dCVV (dynamic card verification value), an expiration date, etc. An authorization request message may also include “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. In some embodiments, it may be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that an issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may include one or more computational apparatuses and may use any of a variety of computing structures, arrangements, and compilations for servicing the requests from one or more client computers. A server computer can be a cloud computer.

A “key” may include a piece of information that is used in a cryptographic algorithm to transform input data into another representation. A cryptographic algorithm can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc.

A “public key” may include an encryption key that may be shared openly and publicly. The public key may be configured such that any information encrypted with the public key may only be decrypted using a private key associated with the public key (i.e., a public-private key pair).

A “private key” may include any encryption key that may be protected and secure. A private key may be securely stored at an entity and may be used to decrypt any information that has been encrypted with an associated public key of a public-private key pair associated with the private key.

A “public-private key pair” may refer to a pair of linked cryptographic keys generated by an entity. The public key may be used for public functions such as encrypting a message to send to the entity or for verifying a digital signature which was made by the entity. The private key, on the other hand may be used for private functions such as decrypting a received message or applying a digital signature. In some embodiments, the public key may be authorized by a body known as a Certification Authority (CA) which stores the public key in a database and distributes it to any other entity which requests it. The private key can typically be kept in a secure storage medium and usually only be known to the entity. Public and private keys may be in any suitable format, including those based on Rivest-Shamir-Adleman (RSA) or elliptic curve cryptography (ECC).

A “Fast Identity Online (FIDO) authentication” is a set of open technical specifications that define user authentication mechanisms that reduce the reliance on passwords.

An “authenticator” is something that authenticates an entity. An authenticator can be a separate authentication device, or authentication software on a user device.

A “FIDO authenticator” is an authentication entity that meets the FIDO Alliance's requirements and which has related metadata. A FIDO authenticator is responsible for user verification, and maintaining the cryptographic material required for the relying party authentication.

A “roaming authenticator” can be an authenticator that can be attached to different devices (e.g., Yubi-key).

“Platform authenticators” are authenticators that are integrated with a user device and capable of capturing an authentication factor. Platform authenticators are called internal authenticators and are used as a part of the FIDO Alliance's FIDO2 authentication standard. Platform authenticators include features embedded with the device as well as biometric scan, although in some cases biometrics might not be required. With platform authenticators, the primary device such as a laptop or smartphone, contains the necessary components of a trusted platform module (TPM), e.g., a Secure Enclave in the Apple example, as well as the fingerprint or facial scanner. When the user actively or passively authenticates, the request is matched against encrypted information on the TPM, and the user may be granted access on the same device.

A user may perform an online transaction using a user's payment credential using a merchant's website. However, with increasing data breaches of user information and online phishing attacks, payment credentials are becoming more vulnerable to the attacks. For example, if an adversary successfully hacks a user account and determines a user's payment credential, then the adversary can perform fraudulent payment transactions by using the user's payment credential.

In order to improve online payment transaction security against adversaries, embodiments can add another layer of security. An authenticator such as an authentication device with certain security guarantees (e.g., FIDO certified) can be used for performing an online payment transaction. The authenticator can generate an assertion public-private key pair, where the assertion public key can be sent to a registered relying party (e.g., a resource provider computer or a computer associated with the resource provider). The authenticator can use the assertion private key on data received from the registered relying party to generate an assertion signature that can prove the authenticity of the authenticator. The relying party can use the assertion public key to verify the assertion signature and authenticate the authenticator. The assertion private key of the authenticator can be stored only in the authenticator and can provide a guarantee that an adversary cannot perform an online transaction without having access to the authenticator.

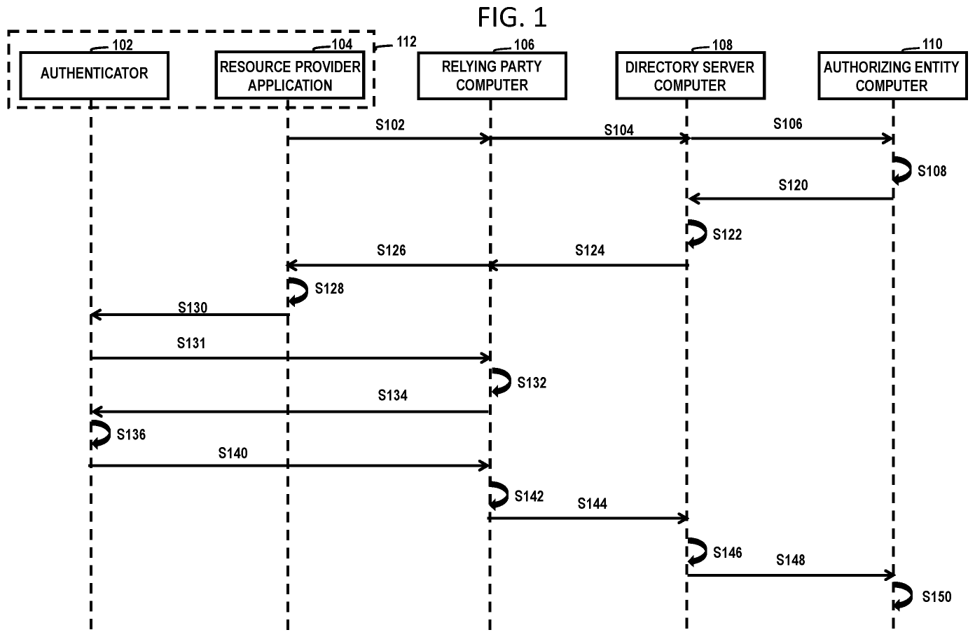

FIG. 1 shows a system and a swim-line flow diagram illustrating a method according to at least one embodiment.

FIG. 1 shows an enrollment method using 3 domain service (3DS) transaction flow. The enrollment method can have at least two stages. As described in detail below, in the first stage, an authorizing entity such as an issuer, which is associated with a user, authenticates the user. In the second stage, an attestation of an authenticator associated with the user device, is performed. Successful attestation completes the user enrollment. In an embodiment, the authorizing entity might not be involved in the operations performed at the second stage.

With continuing reference to FIG. 1, a user device 112 including an authenticator 102 (e.g., FIDO authenticator or authentication device) and a resource provider application 104, a relying party computer 106 (e.g., a resource provider computer associated with the resource provider application 104), a directory server computer 108, and an authorizing entity computer 110 (e.g., an issuer computer) can be in operative communication with each other.

The authenticator 102 can be any suitable hardware or software, or combination thereof, that can perform authentication. In some embodiments, the authenticator 102 can use a FIDO protocol. For example, the authenticator 102 may include an authenticator application installed on the user device 112. The user device 112 can be operated by a user requiring authentication. In some embodiments, the authenticator 102 may be provided in association with the user device 112 but separately from the user device 112. In embodiments, the authenticator 102 can authenticate a user of the user device 112 or the user device 112 itself.

In certain embodiments, the authenticator 102 can be a platform authenticator embedded in the user device 112.

The relying party computer 106 may be a computer associated with the resource provider (e.g., a merchant) and operated by a relying party. Every relying party has a relying party identifier (RP ID) and may be associated with one or more resource providers (e.g., merchants). In some instances, the relying party computer 106 is a computer operated by the resource provider, e.g., a merchant.

The resource provider application 104 may be an application associated with the resource provider involved in the enrollment of the user. The resource provider application 104 may be installed on the user device 112 and/or may be invoked (e.g., loaded or executed) by the user device 112 based on an event, e.g., a user action, a push action from an external device, etc. For example, the resource provider application 104 can facilitate the authentication of the user by the authorizing entity computer 110. Herein, the authentication of this process can be referred to as “prior authentication.”

In some embodiments, the directory server computer 108 may provide a platform for conducting some of the operations of the authorizing entity computer 110. That is, some of the operations typically conducted by the issuer computer during the enrollment and subsequent authentication of the user device 112, e.g., a user, may be shifted to the directory server computer 108. This provides an additional layer of security from a source, e.g., an entity operating the directory server computer 108, which is trusted by the authorizing entity operating the authorizing entity computer 110. As such, additional validations/verifications and repeated attempts to authorize the payment transaction are not needed, thereby reducing network traffic.

The authorizing entity computer 110 may be an issuer computer. The authorization entity operating the authorizing entity computer 110 can be an issuer having the authority to authenticate the user and authorize a transaction.

Each of the entities shown in FIG. 1 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol

(WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

With continuing reference to FIG. 1, a user can access the resource provider application 104 to process a payment transaction or a non-payment authentication (NPA) cardholder authentication transaction. The user can provide user information including personal user information (e.g., one or more of a user identifier (ID), a user device ID (e.g., a phone number, SIM card number, IMEI number, etc.), a username, a password, etc.) and/or payment information (e.g., payment credential, credit card number, CVV, etc.), to the resource provider application 104. The resource provider application 104 may generate a challenge authentication request message, by concatenating the user personal information and the payment information. The challenge authentication request message may also include resource provider information, e.g., a resource provider ID.

In operation S102, the resource provider application 104 may send the challenge authentication request message to the relying party computer 106.

In operation S104, the relying party computer 106 can transmit the challenge authentication request message to the directory server computer 108. The directory server computer 108 can search a routing directory and can identify the authorizing entity computer 110 based on a credential in the personal user information. For example, the credential may be a primary account number, and the authorizing entity computer 110 can be identified using the first six digits of the primary account number. The first six digits can then be mapped to a network address (e.g., an IP address) of the authorizing entity computer 110.

In operation S106, the directory server computer 108 can transmit the challenge authentication request message to the authorizing entity computer 110.

However, the described-above is not intended to be limiting. For example, the resource provider application 104 can transmit the challenge authentication request message directly to the authorizing entity computer 110. As another example, the relying party computer 106 can transmit the challenge authentication request message directly to the authorizing entity computer 110.

In operation S108, upon receiving the challenge authentication request message, the authorizing entity computer 110 can perform the requested authentication by contacting the user and asking the user to provide a secret such as a password or the like. In some embodiments, the authorizing entity computer 110 can look up the contact information for the user using the credential in the challenge authentication request message, and can ask for and receive the secret from the user. In other embodiments, the authorizing entity computer 110 can send a request for the password to the user device 112 and receive a response including the password from the user device 112. For example, the authorizing entity computer 110 can send the request and receive the response via the directory server computer 108 and/or the relying party computer 106. After the secret is received by the authorizing entity computer 110, the authorizing entity computer 110 can compare the secret and the information from the challenge authentication request message with the information stored for a particular user and the particular resource provider, and determine whether the user may be authenticated.

Upon successfully authenticating the user, the authorizing entity computer 110 can generate a challenge authentication response message. For example, the authorizing entity computer 110 can determine, obtain, or generate an access control server (ACS) transaction ID. The authorizing entity computer 110 can generate the challenge authentication response message to include an indication that the user was successfully authenticated and the ACS transaction ID. The ACS transaction ID can be used by the authorizing entity computer 110 to identify the transaction. For example, the authorizing entity computer 110 can store the ACS transaction ID in a memory associated with the authorizing entity computer 110. In some embodiments, the ACS transaction ID can contain the time of the authentication, e.g., the enrollment authentication or “prior” authentication.

The indication that the user was successfully authenticated serves as a proof that the user has a relationship with the authorizing entity computer 110 (e.g., the authorizing entity computer 110 is a holder of the user's account) and that the resource provider associated with the resource provider ID in the challenge authentication request message has a relationship with the user (e.g., the resource provider previously conducted business with the user). In some embodiments, the indication that the user was successfully authenticated may be in the form of a cryptogram. The cryptogram can encrypt one or more of the pieces of information described above using a cryptographic key.

In operation S120, the authorizing entity computer 110 can send the challenge authentication response message to the directory server computer 108.

In operation S122, the directory server computer 108, upon receipt of the challenge authentication response message from the authorizing entity computer 110, can determine, obtain, or generate a directory service (DS) transaction ID. The directory server computer 108 can append to the challenge authentication response message the DS transaction ID. The DS transaction ID can be used by the directory server computer 108 to identify the transaction. For example, the directory server computer 108 can store the DS transaction ID in a memory associated with the directory server computer 108. Optionally, the directory server computer 108 can record a time of when the enrollment authentication is performed.

In operation S124, the directory server computer 108 can send the challenge authentication response message including the indication that the user was successfully authenticated, the ACS transaction ID, and the DS transaction ID to the relying party computer 106, thereby informing the relying party computer 106 that the user was successfully authenticated by the authorizing entity computer 110.

In operation S126, the relying party computer 106 can transmit the challenge authentication response message including the indication that the user was successfully authenticated, the ACS transaction ID, and the DS transaction ID to the resource provider application 104.

After successful authentication of the user by the authorizing entity computer 110 at the first stage of the enrollment process, a credential enrollment and attestation process can be initiated using the authenticator 102, the relying party computer 106, and the resource provider application 104.

For example, at operation S128, the resource provider application 104 may display a user interface (UI) on the user device 112, asking the user to confirm enrollment.

At operation 130, in response to the user input through the UI confirming the enrollment, the resource provider application 104 may invoke the authenticator 102, e.g., an authenticator application. However, this is not indented to be limiting and the authenticator 102 may be invoked by another event, e.g., by a user accessing the authenticator application.

At operation S131, the authenticator 102 can send the request for enrollment authentication to the relying party computer 106, thereby initiating a credential enrollment and attestation process.

In operation S132, upon receiving the request for enrollment authentication, the relying party computer 106 can generate, obtain, or determine relying party (RP) credential parameters. For example, the RP credential parameters may include a challenge, an RP ID, an authenticator selection, an attestation setting, a user verification setting, a user present setting, etc. The challenge can be a random number generated to prevent replay attacks. The RP ID can be a unique identifier (e.g., a valid domain string, application address, etc.) that identifies the relying party domain. In some embodiments, RP ID may be set to the origin's effective domain, e.g., of the relying party computer 106. In other embodiments, the RP ID may be set to a different value, e.g., an equivalent of the origin's effective domain or a registrable domain suffix.

The authenticator selection can be specific authenticator information that the relying party computer 106 may require. For example, the relying party computer 106 may require a specific type of authenticator. In an embodiment, the relying party computer 106 may require a platform authenticator that is a FIDO authenticator capable of being embedded inside the user device 112. However, this is not intended to be limiting and other type of authenticator may be used.

The attestation setting can allow the resource provider computer to specify whether the attestation data is required. The attestation data may include an authenticator attestation globally unique ID (AAGUID) that indicates the certified FIDO device. The same AAGUID may be assigned to security keys whose product type and firmware are the same.

In some embodiments, the relying party computer 106 can set the attestation setting to “direct.” Such setting specifies that the attestation of the FIDO certification is required, e.g., the authenticator 102 must be the certified FIDO device possessing an AAGUID.

The user verification setting and the user present setting may allow the relying party computer 106 to instruct the authenticator 102 whether the user verification and the user presence are required. In embodiments, the user verification setting and the user present setting may be set by the relying party computer 106 to indicate that the user verification and the user presence are required.

The relying party computer 106 can generate an authenticator attestation request packet which includes at least the RP credential parameters described above.

In operation S134, the relying party computer 106 can send an authenticator attestation request packet including the RP credential parameters to the authenticator 102.

In operation S136, upon receiving the authenticator attestation request packet, the authenticator 102 can validate the RP ID in the authenticator attestation request packet. For example, the authenticator 102 can determine whether the RP ID matches an origin's RP ID such as a website URL or an application address of the relying party computer 106 (e.g., of the relying party). If these parameters do not match, the authenticator 102 may reject the enrollment authentication and end the enrollment process.

The authenticator 102 can facilitate user authentication. For example, the authenticator 102 can authenticate the user (e.g., by using user-provided PIN, user biometric information, etc.). In addition to the user authentication, the authenticator 102 can determine if the user is present during authentication, which can involve an affirmative user gesture (e.g., touching the authenticator 102) or a real-time user image can be captured by an image sensor included in the authenticator 102 or in the user device 112.

In some embodiments, the authenticator 102 can generate or be provided with an attestation cryptographic key pair and an attestation certificate in the process of manufacturing of the authenticator 102. The attestation cryptographic key pair and an attestation certificate can be specific to the authenticator 102. In some cases, all devices with the same device model would have same attestation cryptographic key pair and certificate. For example, if the authenticator 102 is a smartphone with a model “123,” then all the model “123” smartphones would have the same attestation cryptographic key pair and certificate. By doing this, the attestation can be used to cryptographically prove to the relying party, e.g., the relying party computer 106 in an embodiment, that an authenticator 102 is a specific model of a device during the enrollment process. Additionally, the attestation root certificate and metadata of the authenticator 102 can be registered with a central repository called Metadata Service (MDS) using the AAGUID. The attestation certificate can be chained to the root certificate that the relying party trusts (similar to a digital certificate).

In some embodiments, the authenticator 102 can generate a new assertion cryptographic key pair, e.g., an assertion public-private key pair, specific to the relying party computer 106. The authenticator 102 can store the assertion private key and the RP ID in a database within the authenticator 102 or in the secure element of the user device 112. The secure element can be a secure chip, as known to those skilled in the art.

The authenticator 102 can generate a credential identifier (ID) that contains information about the new assertion public key, the new assertion private key, and/or RP ID. For example, the credential ID may include information about the location of the new assertion private key and the RP ID in the database of the authenticator 102.

In some embodiments, the authenticator 102 can use the attestation private key and a first concatenated value to generate an attestation signature. For example, the attestation signature can be used to sign the first concatenated value, to generate the attestation signature. The first concatenated value can be a concatenation of a hash of the authenticator data and a client data hash that is determined by applying a hash algorithm to the authenticator data and the client data hash. Alternatively, the first concatenated value can be a concatenation of a hash of the authenticator data and client data that is determined by applying a hash algorithm to the authenticator data and the client data. The hash algorithm may be SHA-256 or any other suitable hash algorithm.

For example, the client data can include one or more of a challenge, RP ID or RP ID hash, and extensions. The authenticator data can include a user verification flag, a user present flag, the AAGUID, an assertion public key of the assertion public-private key pair, a credential ID, etc. In some embodiments, the authenticator data can further include a cryptographic algorithm identifier for a cryptographic algorithm used to generate the assertion public-private key pair.

After the validation/authentication steps described above are performed (e.g., successfully accomplished), the authenticator 102 may generate an authenticator attestation response packet that may include the client data and an attestation object. The user verification flag and the user present flag can be set to “true” indicative of user successful verification (e.g., PIN or biometric authentication) and user presence. For example, as used herein, a value of “true” is 1, among 0 and 1.

In some embodiments, the attestation object can include an attestation format, the authenticator data, and an attestation statement. In some embodiments, the attestation format can be used to determine how to verify the attestation statement. For example, the attestation format can be “packed”, “fido-u2f”, “none”, “android-key”, “android-safetynet”, “tpm”, “apple”, etc.

The structure of the attestation statement and the procedures to verify it may depend on the type of the attestation format that is defined in the attestation object. In some embodiments, the attestation statement can include the attestation signature and the attestation certificate.

In operation S140, the authenticator 102 can send the authenticator attestation response packet to the relying party computer 106 as a response to receiving the authenticator attestation request packet. In some embodiments, the authenticator 102 can also send the user device ID for the user device participating in the enrollment.

In operation S142, upon receiving the authenticator attestation response packet from the authenticator 102, the relying party computer 106 can verify the client data and the attestation object.

As described in detail below, in some embodiments, the relying party computer 106 can verify the RP ID, the challenge in the client data, the attestation signature, the user verification flag, the user present flag, AAGUID, and the attestation certificate. If any of verifications fails, the enrollment process aborts.

For example, the relying party computer 106 may verify that the RP ID in the client data is the same as the origin RP ID (e.g., URL) of the relying party computer 106, to verify that there is no phishing or man-in-the-middle attack between the authenticator 102 and the relying party computer 106.

The relying party computer 106 can verify that the challenge in the client data matches the challenge sent in the authenticator attestation request packet, and confirm that the user verification flag and the user present flag are set to “true.”

The relying party computer 106 can verify the attestation signature of the attestation object using the attestation public key. The relying party computer 106 may be previously provided with the attestation public key.

For example, the relying party computer 106 can use the attestation signature and the attestation public key, to determine the first concatenated value. The relying party computer 106 may generate a second concatenated value. If the client data hash is received, the second concatenated value can be a concatenation of a hash of the received authenticator data and the received client data hash that is determined by applying a hash algorithm to the received authenticator data and the received client data hash. Alternatively, if the client data is received that is not hashed, the second concatenated value is a concatenation of a hash of the received client data and authenticator data that is determined by applying a hash algorithm to the received client data and authenticator data. If the first concatenated value matches the second concatenated value, then the attestation signature is considered as verified.

The relying party computer 106 may validate the AAGUID, by looking up the AAGUID using the MDS.

In some embodiments, the relying party computer 106 can verify the received attestation certificate, which is used for the verification of authenticity of the attestation signature. The attestation certificate can be verified by using the received AAGUID. The AAGUID can be used to look up a metadata statement in a service such as Metadata Service (MDS) to validate authenticator attestation and prove the genuineness of the device model. The metadata statement can have an attestation root certificate and the metadata about the authenticator 102 such as security and biometric characteristics of the device. The root certificate can be used to check the authenticity of the attestation certificate. In some embodiments, other metadata including the security and biometric characteristics can be checked by the relying party computer 106 to determine the security level of the authenticator 102.

Upon successful verifications, the relying party computer 106 can store the credential ID, AAGUID, and the assertion public key in memory. The relying party computer 106 can also store a cryptographic algorithm identifier for a cryptographic algorithm used to generate the assertion public-private key pair in correspondence to the assertion public key.

Attestation accomplishes several security checks. For example, if an attacker intercepts the authenticator attestation response packet, the attacker would not be able to swap out the new assertion public key with its own since the attestation signature would not match. As another example, knowing the provenance of the authenticator 102 can provide the relying party with information regarding the security of the encryption keys, the security of the biometrics verification process, etc.

In operation S144, the relying party computer 106 can send an enrollment blob (e.g., an enrollment authentication data packet or enrollment payload) to the directory server computer 108. The enrollment blob can include one or more of an authentication time, an RP ID, an assertion public key, an AAGUID, a used for this transaction flag, a user present flag, a user verification flag, a cryptographic algorithm identifier for a cryptographic algorithm used to generate the assertion public-private key pair, an ACS transaction ID, and a DS transaction ID.

The relying party computer 106 can send the enrollment blob to the directory server computer 108 using a non-payment authentication (NPA) with a requestor challenge indicator.

In operation S146, the directory server computer 108 can validate the information provided in the enrollment blob and, in the case of the successful validation, store the enrollment blob in a memory associated with the directory server computer 108.

As described in detail below, in some embodiments, the directory server computer 108 can validate (e.g., verify) the AAGUID (e.g., by looking up the AAGUID using the MDS), the time period between the time of the enrollment and the time of authentication (i.e., time of prior authentication), and ACS transaction ID. For example, the ACS transaction ID may include time of prior authentication.

For example, the directory server computer 108 can retrieve the previously stored ACS transaction ID and verify the ACS transaction ID in the enrollment blob by comparing the ACS transaction ID in the enrollment blob with the previously stored ACS transaction ID. For example, a match must be determined for a successful verification (e.g., validation).

The directory server computer 108 can verify that the time period between the time of the enrollment, e.g., an enrollment time, and the time of authentication is less than a threshold time period value. For example, the threshold time period value may be set to 2 minutes, 5 minutes, 10 minutes, etc. For example, if a difference between the time of prior authentication and the time of the enrollment recorded in the enrollment blob is more than the threshold time period value, the directory server computer 108 does not validate the time period. Otherwise, the directory server computer 108 validates the time period.

Upon completing successful validation of the AAGUID, the time period, ACS transaction ID, and the DS transaction ID (if available), the directory server computer 108 can store the enrollment blob in the memory associated with the directory server computer 108. For example, the cryptographic algorithm identifier for the cryptographic algorithm used to generate the assertion public-private key pair may be stored in correspondence with the assertion public key.

As described above, the relying party computer 106 may be associated with more than one resource provider. In some embodiments, the processing described above may be performed with respect to a plurality of resource providers associated with a plurality of resource provider applications, using the same authentication computer and same relying party computer. In such embodiments, a plurality of resultant enrollment blobs each associated with a corresponding resource provider may be obtained and stored, by the directory server computer 108.

In operation S148, the directory server computer 108 can send the enrollment blob including the indication that the user was successfully enrolled, the ACS transaction ID, and/or the DS transaction ID to the authorizing entity computer 110 using the NPA with the requestor challenge indicator set to “06” indicating that no challenge requested and the enrollment blob is provided only for data sharing. When the requestor challenge indicator is set to “06,” it means that the authorizing entity computer 110, e.g., the issuer computer, is not allowed to challenge the transaction. A response “I” is expected from the ACS, indicating an acknowledgement of the requestor challenge indicator setting (“06”) and that the enrollment blob is informational.

In some embodiments, at operation S150, the authorizing entity computer 110 may store the enrollment blob in a memory associated with the authorizing entity computer 110.

Upon receiving the enrollment blob, the authorizing entity computer 110 can retrieve the previously stored ACS transaction ID and verify the transaction using the ACS transaction ID from the enrollment blob.

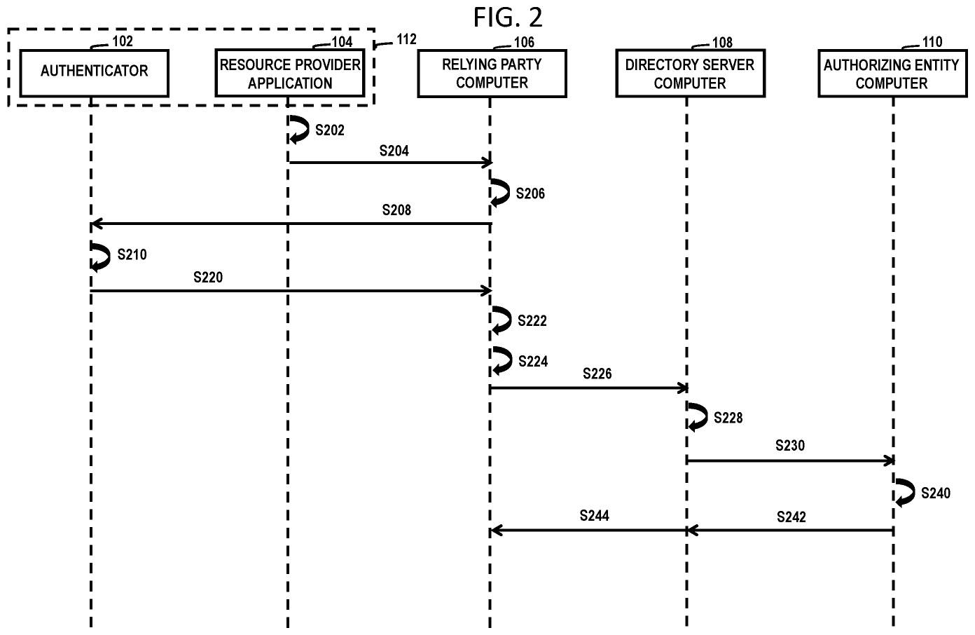

FIG. 2 shows a system and a swim-line flow diagram illustrating a method according to at least one embodiment. The method of FIG. 2 may be a method for assertion authentication.

The assertion authentication may be conducted during an interaction of the user with the resource provider, for example, when the user wishes to pay for the goods or services, after the enrollment process, during which the initial authentication of the user by the issuer and the attestation of the authenticator are performed.

In operation S202, a user of the user device 112 can access and use the resource provider application 104. For example, the user may also access and use the authenticator 102.

In operation S204, the relying party computer 106 may receive, from the resource provider application 104 upon user using the authenticator 102, an indication to perform an authentication process, e.g., an assertion process, associated with the interaction.

In operation S206, the relying party computer 106 may generate an assertion request data packet to include the RP credential parameters (e.g., an RP ID, a credential ID, and a challenge). The assertion request data packet may specify that the user verification and/or the user presence are required. The RP credential parameters are described above.

In operation S208, the relying party computer 106 may send the assertion request data packet including an RP ID, a credential ID, and a challenge to the authenticator 102.

In operation S210, upon receiving the assertion request data packet, the authenticator 102 can perform an assertion process and generate an assertion response data packet, as a response to the assertion request data packet.

The authenticator 102 may compare the RP ID with its origin (e.g., URL) to verify that there is no phishing or man-in-the-middle attack between the authenticator 102 and the relying party computer 106. If the RP ID does not match its origin (e.g., URL), the process aborts.

The authenticator 102 can retrieve the assertion private key and an RP ID stored in the database using the credential ID. The RP ID received from the relying party computer 106 is then compared with the RP ID stored in the authenticator 102 to verify that the correct assertion private key has been retrieved.

The authenticator 102 can generate client data including any of the challenge, RP ID, extensions, and a hash algorithm. In some embodiments, the authenticator 102 can generate a client data hash.

The authenticator 102 can then conduct user presence and user verification that are processes similar to what is described above with reference to FIG. 1. Upon successful user verification and user presence check, the user present flag and the user verification flag can be set “true.” The authenticator 102 can also generate a signature counter, where the signature counter increments every time the authenticator 102 authenticates the user. The signature counter can be used by the relying party computer 106 to detect cloned authenticators. The authenticator 102 can then generate an authenticator data including the AAGUID, the user present flag, user verification flag, extensions, and the signature counter.

The authenticator 102 can use the assertion private key on a first concatenated value to generate an assertion signature. For example, the first concatenated value may be signed with the assertion private key to generate an assertion signature. The first concatenated value can be a concatenation of a hash of the authenticator data and the client data that is obtained by applying a hash algorithm on the authenticator data and the client data. Alternatively, the first concatenated value may be a concatenation of a hash of the authenticator data and the client data hash that is obtained by applying a hash algorithm on the authenticator data and the client data hash. The hash algorithm may be SHA-256 or any other suitable hash algorithm.

The authenticator 102 can generate an assertion response data packet. The assertion response data packet may include the RP ID, the authenticator data, the client data, the credential ID, and the assertion signature.

In operation S220, the authenticator 102 can send the assertion response data packet to the relying party computer 106, as a response to the assertion data request packet.

In operation S222, the relying party computer 106 can verify the assertion response data packet.

As described in detail below, in some embodiments, the relying party computer 106 can verify the RP ID, the challenge in the client data, the assertion signature, the user verification flag, the user present flag, the credential ID, and AAGUID. If any verification fails, the process aborts.

For example, the relying party computer 106 can compare the RP ID in the assertion response data packet with the origin RP ID (e.g., URL) to verify that there is no phishing or man-in-the-middle attack between the authenticator 102 and the relying party computer 106.

The relying party computer 106 can verify that the challenge in the client data matches the generated challenge, the user verification flag and the user present flag are set as “true,” the AAGUID of the authenticator data matches the

AAGUID used during the enrollment, and the credential ID of the assertion data response packet matches the stored credential ID.

The relying party computer 106 can also validate (e.g., verify) the assertion signature. For example, the relying party computer 106 can use the assertion public key and the assertion signature to determine the first concatenated value. In some embodiments, the relying party computer 106 can apply a predefined algorithm on the assertion public key and the assertion signature to determine the first concatenated value. In some embodiments, the predefined algorithm may be the cryptographic algorithm used to generate the assertion public-private key pair. The relying party computer 106 can further generate a second concatenated value. If the client data received that is not hashed, the second concatenated value can be a concatenation of a hash of the received authenticator data and client data that is obtained by applying the hash algorithm on the received authenticator data and client data. If the client data received that is hashed, the second concatenated value can be a concatenation of the received authenticator data and the received client data hash that is obtained by applying the hash algorithm on the received authenticator data and client data hash. The hash algorithm may be SHA-256 or any other suitable hash algorithm. If the first concatenated value matches the second concatenated value, then the assertion signature is validated, e.g., verified.

In some embodiments, the relying party computer 106 can ensure, e.g., determine, that all verifications are successful; otherwise, the assertion/authentication is aborted.

In operation S224, in response to all the validations and verifications being successful, the relying party computer 106 can generate an authentication data packet, e.g., the authentication payload or the authentication blob. For example, the authentication data packet transmitted to the directory server computer 108 includes a requestor authentication method and authentication data.

The requestor authentication method be represented by a string corresponding to the authentication method, e.g., 3DS.

The authentication data includes an authentication time, RP ID, an authenticator ID (e.g., AAGUID), a used for this transaction flag, a user present flag, a user verification flag, an assertion signature, the client data, and the authenticator data. Each of the authentication time, RP ID, AAGUID, a used for this transaction flag, a user present flag, a user verification flag, an assertion signature, the client data, and the authenticator data may be disposed in a corresponding data field of the authentication data packet. For example, each of the authentication time, RP ID, AAGUID, a used for this transaction flag, an assertion signature, the client data, and the authenticator data can be represented by a string. Each of the user present flag and the user verification flag is a Boolean bit flag.

The authentication time, the RP ID, the AAGUID, the user present flag, the user verification flag, the assertion signature, the client data, and the authenticator data are described above. If the RP ID and the AAGUID match the previously used RP ID and AAGUID, the processing proceeds. The user present flag and the user verification flag can be set to “true,” e.g., 1. The used for this transaction flag can be set to true indicating that the same authenticator was used to authenticate the current session with the resource provider.

In operation S226, the relying party computer 106 can transmit the authentication data packet to the directory server computer 108.

In operation S228, upon receiving the authentication data packet, the directory server computer 108 can verify the information in the authentication data packet. In certain embodiments, the directory server computer 108 may store the authentication data packet, e.g., in a database in correspondence to the user device ID, if the verifications/validations described below are successful.

As described in detail below, in some embodiments, the directory server computer 108 can validate (e.g., verify) the RP ID, the AAGUID, the assertion signature, the user present flag, and the user verification flag.

For example, the directory server computer 108 may use the AAGUID to check that the same authentication device (e.g., the authenticator 102) is used for the assertion as was used during the enrollment. The directory server computer 108 can check that the user present flag and the user verification flag are set to true. The directory server computer 108 can check that RP ID matches the resource provider. The directory server computer 108 can verify the assertion signature using the assertion public key similar to operation S222.

In certain embodiments, the directory server computer 108 can ensure, e.g., determine, that all verifications are successful; otherwise, the assertion/authentication is aborted.

In operation S230, upon successful verifications in operation S228, the directory server computer 108 can transmit the data related to the verification of the authentication data to the authorizing entity computer 110. For example, the directory server computer 108 can transmit the authentication data packet with an indication “Must Approve” to the authorizing entity computer 110. The authorizing entity computer 110, upon receiving the authentication data packet, can verify the authentication data included in the authentication data packet. For example, the authorizing entity computer 110 can verify one or more of the RP ID, the AAGUID, and the assertion signature. The methods for verifying the RP ID, the AAGUID, and the assertion signature are described above with reference to the operation S222.

In some embodiments, the format of messages in operations S226 and S230 can be a 3DS message format.

In operation S240, if all the data are successfully validated, e.g., verified, in operation S230, the authorizing entity computer 110, e.g., the issuer computer, can generate security data indicating that the validation is successful. For example, the authorizing entity computer 110 can generate a cryptogram or a message (e.g., ECI 05/CAVV) indicating that the validation is successful. For example, a cryptogram may be an authentication cryptogram.

In operation S242, the authorizing entity computer 110 can transmit data packet including security data, e.g., the cryptogram, to the directory server computer 108.

In operation S244, the directory server computer 108 can transmit the data packet including security data, e.g., the cryptogram, to the relying party computer 106.

As described in detail below, the cryptogram may be incorporated into an authorization request message that is later sent to the authorizing entity computer 110 via a transport computer and a processing server computer (e.g., a payment processing network computer). The presence of the cryptogram in the authorization request message provides assurance to the authorizing entity computer 110 that the user and/or the user device was properly authenticated for the transaction. This can be a factor in approving the authorization request message. Later, an authorization response message is sent from the authorizing entity computer 110 to the relying party computer 106 via the transport computer and the processing server computer. Then, a clearing and settlement process can take place between the processing server computer, the transport computer, and the authorizing entity computer 110 to settle the transaction.

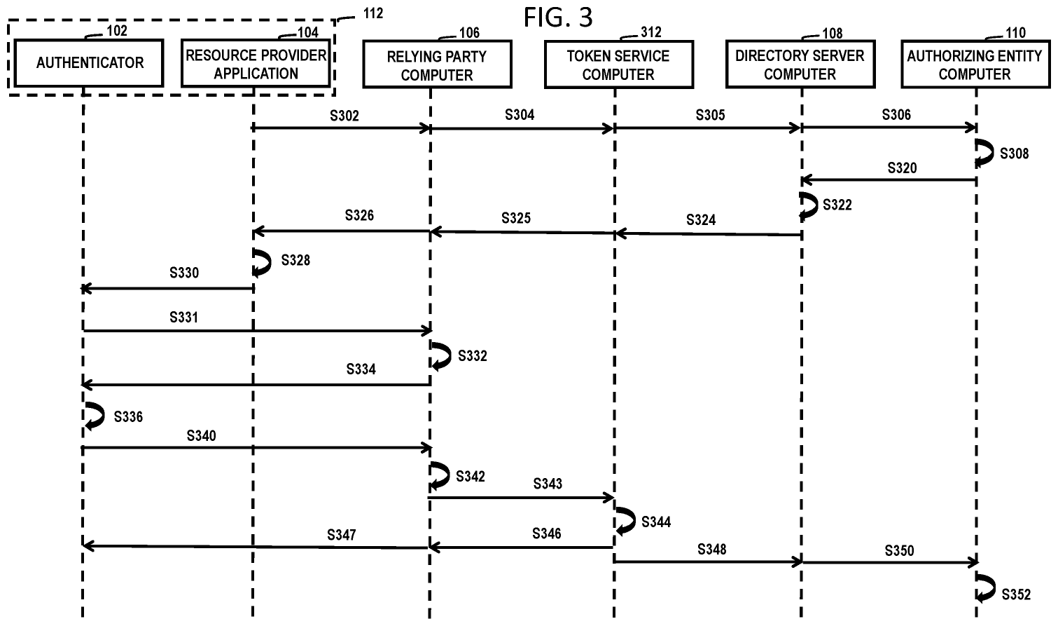

FIG. 3 shows a system and a swim-line flow diagram illustrating a method according to at least one embodiment. The method can include a method for enrolling using a cloud token framework (CTF) transaction flow.

An authenticator 102, a resource provider application 104, a relying party computer 106, a token service computer 312, a directory server computer 108, and an authorizing entity computer 110 are shown and can be in operative communication with each other. An authenticator 102, a resource provider application 104, a relying party computer 106, a directory server computer 108, and an authorizing entity computer 110 are the same components as described above with reference to FIG. 1 and repeated descriptions will be omitted.

Each of the entities shown in FIG. 3 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

Operation S302 corresponds to operation S102 of FIG. 1 and the description thereof will not be repeated.

In operation S304, the relying party computer 106 can transmit the challenge authentication request message to the token service computer 312. The challenge authentication request message includes a credential such as a primary account number (PAN).

In operation S305, the token service computer 312 can transmit the challenge authentication request message to the directory server computer 108.

Operations S306 to S322 correspond to operations S106 to S122 of FIG. 1 and the description thereof will not be repeated.

In operation S324, the directory server computer 108 can send the challenge authentication response message including the credential, the indication that the user was successfully authenticated, the ACS transaction ID, and the DS transaction ID to the token service computer 312. The challenge authentication response message may include a time of enrollment authentication. The DS transaction ID can be stored in a memory associated with the token service computer 312.

Optionally, upon receiving the challenge authentication response message, the token service computer 312 can tokenize the payment credential to obtain a payment token. The payment token can be stored in the memory associated with the token service computer 312.

In operation S325, the token service computer 312 can send the challenge authentication response message including the payment token, the indication that the user was successfully authenticated, the ACS transaction ID, and the DS transaction ID to the relying party computer 106, thereby informing the relying party computer 106 that the user was successfully authenticated by the authorizing entity computer 110.

Operations S326 to S342 can correspond to operations S126 to S142 of FIG. 1 and the description thereof will not be repeated.

In operation S343, the relying party computer 106 can send an enrollment blob and a device binding request to the token service computer 312. For example, the device binding request may include the user device ID for the user device that participated in enrollment.

The enrollment blob is described above and can include at least one from among an authentication time, an RP ID, an assertion public key, an AAGUID, a used for this transaction flag, a user present flag, a user verification flag, a cryptographic algorithm identifier for a cryptographic algorithm used to generate the assertion public-private key pair, an ACS transaction ID, and a DS transaction ID. The generation of the assertion public-private key pair is described above with reference to operation S136 that corresponds to operation S336 of FIG. 3.

The device binding request includes a device enrollment request for a token service based on the device identifier, e.g., a user device identifier, and the assertion public-private key pair.

In operation S344, upon receiving the enrollment blob, the token service computer 312 can verify the contents of the enrollment blob. The verifications are similar to the verifications performed in operation S146.

For example, the token service computer 312 validate the AAGUID by looking up the AAGUID using the MDS.

The token service computer 312 can retrieve the previously stored ACS transaction ID and verify the ACS transaction ID in the enrollment blob by comparing the ACS transaction ID in the enrollment blob with the previously stored ACS transaction ID. For example, a match must be determined for a successful verification (e.g., validation).

In some embodiments, the token service computer 312 may also validate that the time period between the time of the enrollment and the time of authentication is less than a threshold time period value. For example, the threshold time period value may be set to 2 minutes, 5 minutes, 10 minutes, etc. For example, if a difference between the time of prior authentication and the time of the enrollment recorded in the enrollment blob is more than the threshold time period value, the token service computer 312 does not validate the time period. Otherwise, the token service computer 312 validates the time period.

Optionally, the token service computer 312 can additionally retrieve the previously stored DS transaction ID and verify the DS transaction ID in the enrollment blob by comparing the DS transaction ID in the enrollment blob with the previously stored DS transaction ID.

Upon completing successful validation of at least the AAGUID, the time period, and the ACS transaction ID, the token service computer 312 can store the enrollment blob in the memory associated with the directory server computer 108. For example, the cryptographic algorithm identifier for the cryptographic algorithm used to generate the assertion public-private key pair may be stored in correspondence with the assertion public key.

Also, in response to the device binding request, the token service computer 312 can bind the payment token generated in operation S324 to the user device 112.

In operation S346, the token service computer 312 can send the payment token and the successful device binding notification to the relying party computer 106.

In operation S347, the relying party computer 106 can send the payment token and the successful device binding notification to the authenticator 102.

In operation S348, the token service computer 312 can send the enrollment blob including the indication of successful assertion, the ACS transaction ID, and/or the DS transaction ID to the directory server computer 108 using the NPA.

For example, the requestor challenge indicator may be set to “06” indicating that no challenge requested and the enrollment blob is provided for data sharing only.

In operation S350, the directory server computer 108 can send the enrollment blob including the indication of successful enrollment authentication, the ACS transaction ID, and the DS transaction ID to the authorizing entity computer 110.

In some embodiments, at operation S352, the authorizing entity computer 110 may store the enrollment blob in a memory associated with the authorizing entity computer 110. The authorizing entity computer 110 can find and verify the payment transaction using the ACS transaction ID stored in the enrollment blob.

In certain embodiments, the method described above with reference to FIG. 3 may be performed without involvement of the directory server computer 108. For example, in some embodiments, all or some of operations S302 to S328 may be omitted. In some embodiments, the messaging may be directly performed between the token service computer 312 and the authorizing entity computer 110, e.g., the token service computer 312 may perform the functions described above with reference to the directory server computer 108.

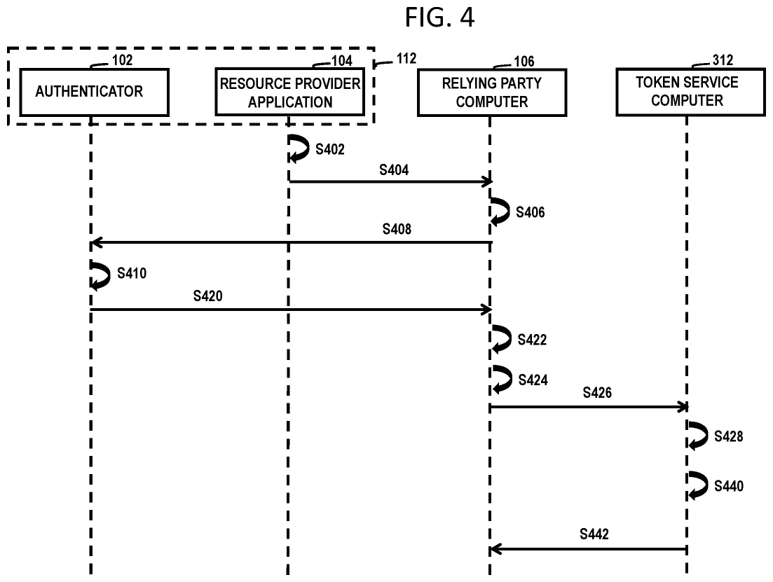

FIG. 4 shows a system and a swim-line flow diagram illustrating a method according to at least one embodiment. The method includes authenticating a user using a cloud token framework (CTF) transaction flow, performing the assertion authentication.

As described above, the assertion authentication is conducted during an interaction of the user with the resource provider, for example, when the user wishes to pay for the goods or services, after the enrollment process, during which the initial authentication of the user by the issuer and the attestation of the authenticator are performed.

Operations S402 to S424 correspond to operations S202 to S224 of FIG. 2 and will therefore not be repeated.

In operation S426, the relying party computer 106 can transmit the authentication data packet to the token service computer 312.

In operation S428, upon receiving the authentication data packet, the token service computer 312 can perform verification of the authentication data included in the authentication data packet. For example, the operation S428 can correspond to operation S228.

For example, the token service computer 312 may use the AAGUID to check that the same authentication device (e.g., the authenticator 102) is used for the assertion as was used during the enrollment described with reference to FIG. 3. The token service computer 312 can additionally check whether the user present flag and the user verification flags are set to “true.” The token service computer 312 can check the assertion signature using the assertion public key similar to operation S228.

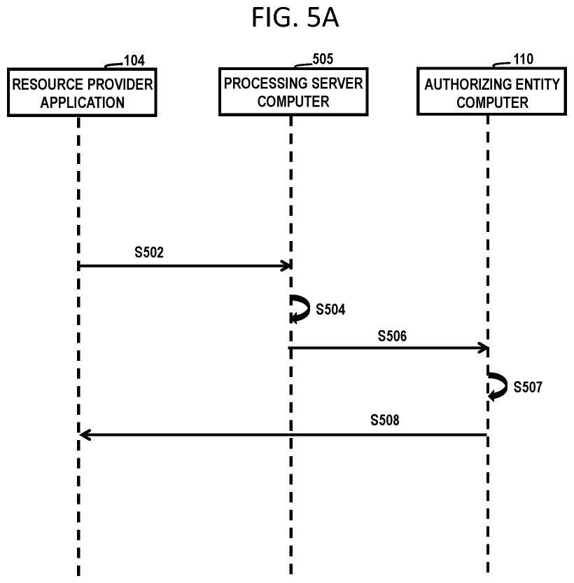

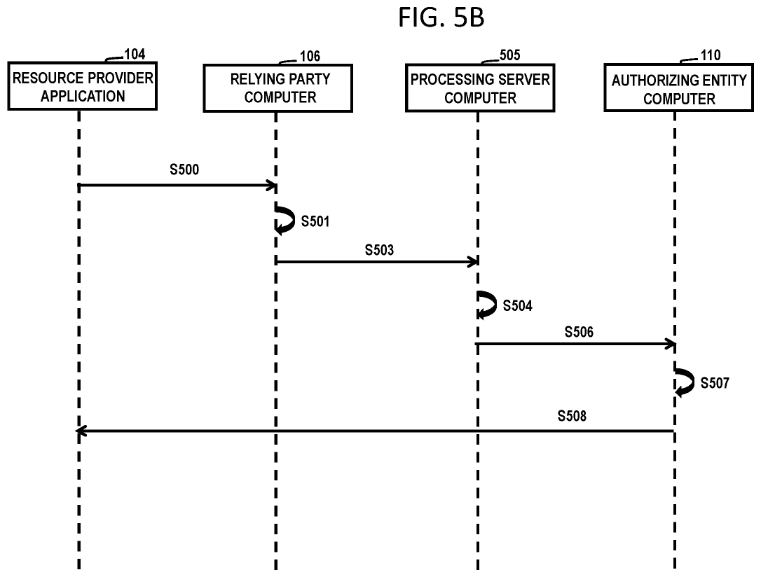

In certain embodiments, the token service computer 312 can ensure, e.g., determine, that all verifications are successful; otherwise, the assertion/authentication is aborted. The token service computer 312 can store the authentication data packet in a database if the verifications/validations are successful. In some embodiments, the token service computer 312 can transmit the authentication data packet to the authorizing entity computer 110. However, this is not intended to be limiting. For example, the token service computer 312 can transmit the authentication data packet to the authorizing entity computer 110 at a later time, e.g., as a part of the process related to the transaction authorization. An example of the transaction authorization process is described below with reference to FIGS. 5A and 5B.

In operation S440, if all the data are successfully validated by the token service computer 312, the token service computer 312 can generate security data indicating that the validation/verification of the authentication data is successful. For example, the token service computer 312 can generate a message or a data packet including a cryptogram (e.g., ECI 05/CAVV) notifying that the validation is successful. For example, the cryptogram can be an authentication cryptogram.

In operation S442, the token service computer 312 can transmit a data packet including the cryptogram to the relying party computer 106.

As described in detail below, the cryptogram may be incorporated into an authorization request message that is later sent to the authorizing entity computer 110 via a transport computer and a processing server computer (e.g., a payment processing network computer). The presence of the cryptogram in the authorization request message provides assurance to the authorizing entity computer 110 that the user and/or the user device was properly authenticated for the transaction. This can be a factor in approving the authorization request message. Later, an authorization response message is sent from the authorizing entity computer 110 to the relying party computer 106 via the transport computer and the processing server computer. Then, a clearing and settlement process can take place between the processing server computer, the transport computer, and the authorizing entity computer 110 to settle the transaction.

FIG. 5A shows a system and a swim-line flow diagram illustrating a method according to at least one embodiment. FIG. 5A shows a method of authorization that may be performed after finishing an enrollment process (e.g., as in FIGS. 1 and 3) and an assertion process (e.g., FIGS. 2 and 4).

A resource provider application 104, a processing server computer 505, and an authorizing entity computer 110 are shown and can be in operative communication with each other. Both 3DS and CTF transaction flows can be used with respect to the authorization process described in FIG. 5A after authentication. The processing server computer 505 and the functionality of the previously described token service computer 312 and/or the directory server computer 108 can be included in a single “server computer” in some embodiments.

Each of the entities shown in FIG. 5A may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

In operation S502, the resource provider application 104 can send to the processing server computer 505, an authorization request message with respect to an interaction (e.g., a transaction) between the user device 112 and the resource provider computer of the resource provider that previously undergone the enrollment and authentication, as described above with reference to FIGS. 1-4.

The authorization request message may include a transaction amount, a token or a credential, and the cryptogram (e.g., ECI 05/CAVV) associated with the user device 112 and the resource provider. The cryptogram in the authorization request message notifies the processing server computer 505 about a previously successful authentication of the user (from either 3DS or CTF transaction flow). In some embodiments, the cryptogram in the authorization request message may include an authentication cryptogram generated in operation S240 or operation S440.

Herein, the cryptogram in the authorization request message may be referred to as the security data.

In operation S504, the processing server computer 505 can enhance, e.g., modify, the authorization request message by including, into the authorization request message, the authentication data included in the authentication data packet that matches the cryptogram. In some embodiments, the processing server computer 505 can obtain the authentication data and/or the authentication data packet from the token service computer 312 and/or the directory server computer 108. The authentication data is described above and can include previous authentication time, the RP ID, the AAGUID, a used for this transaction flag, a user present flag, a user verification flag, the assertion signature, the client data, and the authenticator data. The processing server computer 505 can also communicate with a token service computer 312 to detokenize the token to obtain the credential associated with the token if a token is in the authorization request message.

In operation S506, the processing server computer 505 can send the modified authorization request message to the authorizing entity computer 110.

In operation S507, upon receiving the modified authorization request message, the authorizing entity computer 110 may determine whether to authorize the transaction. In addition to determining if the user has sufficient funds in their account, the authorizing entity computer 110 can use the data in the authentication data packet in the authorization request message to determine if the current transaction is authorized. The authentication data is detailed and can provide the authorizing entity (e.g., the issuer) with assurance that the transaction is authentic.

In operation S508, the authorizing entity computer 110 can send an authorization response message including either an acceptance or rejection of the authorization request message. If the authorizing entity computer 110 authorizes the authorization request message, then the payment transaction successfully proceeds. If the authorizing entity computer 110 declines the authorization request message, then the payment transaction terminates.

FIG. 5B shows a system and a swim-line flow diagram illustrating a method according to at least one embodiment. FIG. 5B shows a method of authorization that may be performed after finishing the enrollment process (e.g., as in FIGS. 1 and 3) and the assertion process (e.g., as in FIGS. 2 and 4).

A resource provider application 104, a relying party computer 106, a processing server computer 505, and an authorizing entity computer 110 are shown and can be in operative communication with each other. Both 3DS and CTF transaction flows can be used with respect to the authorization process described in FIG. 5B after authentication. The processing server computer 505 and the functionality of the previously described token service computer 312 and/or the directory server computer 108 can be included in a single “server computer” in some embodiments.

In an example, a user may use the resource provider application 104 to initiate a transaction with the resource provider operating the resource provider computer, or the resource provider computer can initiate the transaction on behalf of the user (e.g., as in a recurring payment transaction).

In operation S500, the resource provider application 104 can send a message to the relying party computer 106, with respect to an interaction (e.g., a transaction) between the user device 112 and the resource provider computer of the resource provider that previously undergone the enrollment and attestation with respect to the user device 112, as described above with reference to FIGS. 1-4.

In operation S501, the relying party computer 106 may receive a message from the resource provider application 104 and may generate an authorization request message on behalf of the resource provider application 104.

For example, the authorization request message may include a transaction amount, a token or a credential, and the cryptogram (e.g., ECI 05/CAVV) associated with the user device 112 and the resource provider. The cryptogram in the authorization request message notifies the processing server computer 505 about a previously successful authentication of the user (from either 3DS or CTF transaction flow).

However, the described above is not intended to be limiting. In certain implementations, the resource provider application 104 may send an authorization request message to the relying party computer 106.

In operation S503, the relying party computer 106 can send the authorization request message including the cryptogram to the processing server computer 505. The cryptogram in the authorization request message notifies the processing server computer 505 about previous successful authentication (from either the 3DS or CTF transaction flow). In some embodiments, the cryptogram in the authorization request message may include the authentication cryptogram generated in operation S240 or operation S440. The cryptogram in the authorization request message may be referred to as the security data.

In operation S504, the processing server computer 505 can enhance, e.g., modify, the authorization request message by including, into the authorization request message, the authentication data included in the authentication data packet that matches the cryptogram. In some embodiments, the processing server computer 505 can obtain the authentication data and/or the authentication data packet from the token service computer 312 and/or the directory server computer 108. The authentication data is described above and can include previous authentication time, the RP ID, the AAGUID, a used for this transaction flag, a user present flag, a user verification flag, the assertion signature, the client data, and the authenticator data. The processing server computer 505 can also communicate with a token service computer 312 to detokenize the token to obtain the credential associated with the token if a token is in the authorization request message.

In operation S506, the processing server computer 505 can send the modified authorization request message to the authorizing entity computer 110.

In operation S507, upon receiving the modified authorization request message, the authorizing entity computer 110 may determine whether to authorize the transaction. In addition to determining if the user has sufficient funds in their account, the authorizing entity computer 110 can use the data in the authentication data packet in the authorization request message to determine if the current transaction is authorized. The authentication data is detailed and can provide the authorizing entity (e.g., the issuer) with assurance that the transaction is authentic.

In operation S508, the authorizing entity computer 110 can send an authorization response message including either an acceptance or rejection of the authorization request message. If authorizing entity computer 110 authorizes the authorization request message, then the payment transaction successfully proceeds. If the authorizing entity computer 110 declines the authorization request message, then the payment transaction terminates.

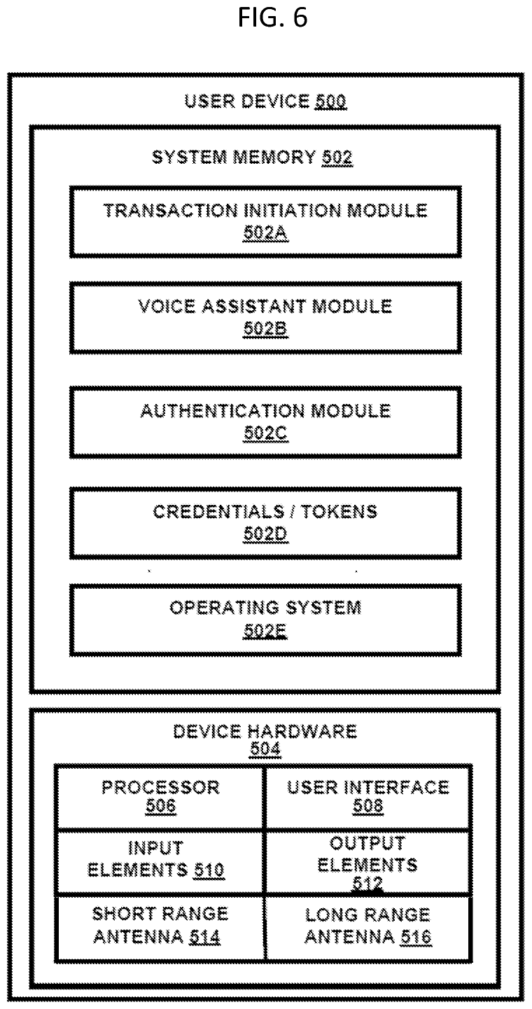

FIG. 6 shows a block diagram of a user device 500 in according to an embodiment. The user device 500 may correspond to the user device 112 described above and may include device hardware 504 coupled to a system memory 502, e.g., a computer-readable storage medium.

Device hardware 504 may include a processor 506, a short range antenna 514, a long range antenna 516, input elements 510, a user interface 508, and output elements 512 (which may be part of the user interface 508). Examples of input elements may include microphones, keypads, touchscreens, sensors, etc. Examples of output elements may include speakers, display screens, and tactile devices.

The long range antenna 516 may include one or more RF transceivers and/or connectors that can be used by user device 500 to communicate with other devices and/or to connect with external networks. The user interface 508 can include any combination of input and output elements to allow a user to interact with and invoke the functionalities of user device 500. The short range antenna 509 may be configured to communicate with external entities through a short range communication medium (e.g., using Bluetooth, Wi-Fi, infrared, NFC, etc.). The long range antenna 516 may be configured to communicate with a remote base station and a remote cellular or data network, over the air.

The system memory 502 can be implemented using any combination of any number of non-volatile memories (e.g., flash memory) and volatile memories (e.g., DRAM, SRAM), or any other non-transitory storage medium, or a combination thereof media. The system memory 502 can be in the form of (or may be included in) a memory element that stores data (e.g., resource provider applications) and can be in any suitable form (e.g., microSD chip, SIM card, or other type of memory element).

The system memory 502 may also store a transaction initiation module 502A, a voice assistant module 502B, an authentication module 502C, credentials and/or tokens 502D, and an operating system 502E. The transaction initiation module 502A may include instructions or code initiating and conducting a transaction with an external device such as an access device or a processing computer. It may include code, executable by the processor 506, for generating and transmitting authorization request messages, as well as receiving and forwarding authorization response messages. It may also include code, executable by the processor 506, for forming a local connection or otherwise interacting with an external device (e.g., an Operator computer). The voice assistant module 502B may include code, executable by the processor 506, to receive voice segments, and generate and analyze data corresponding to the voice segments. The authentication module 502C may include code, executable by the processor 506, to authenticate a user. This can be performed using user secrets (e.g., passwords) or user biometrics. For example, the authenticator 102 may be incorporated into or be a part of the authentication module 502C. System memory 502 may also store credentials and/or tokens or references to credentials and/or tokens 502D.

The system memory 502, e.g., the computer-readable medium can store code, executable by the processor 506 for implementing a method including:

generating, using an authenticator 102 associated with a user device 500 (or 112), a public-private key pair; authenticating, using the authenticator 102, a user of the user device; generating, using the authenticator 102, a client data and an authenticator data, the authenticator data including an indication that the user has been authenticated by the authenticator 102; generating, using the authenticator 102, an assertion signature by signing a concatenated value with a private key of the public-private key pair, where the concatenated value is formed by concatenating the client data and the authenticator data; sending a data packet including the client data, the authenticator data, and the assertion signature to a relying party computer 106, where the relying party computer 106 validates the assertion signature using the received client data and authenticator data and a public key of the public-private key pair, and, based at least on the assertion signature being validated, generates an authentication data packet including an authentication data, the authentication data including the assertion signature, the client data, and the authenticator data, and sends the authentication data packet to a server computer. The server computer thereafter receives the authentication data packet, verifies the authentication data in the authentication data packet, stores the authentication data packet in a database, and transmits, to an authorizing entity computer 110, a data packet including data relating to the verification of the authentication data.

Herein, the server computer may refer to the directory server computer 108, the token service computer 312, or the processing server computer 505, or any combination thereof.

Embodiments of the invention have a number of technical advantages.

For example, the directory server computer 108 (or the token service computer 312) may provide a platform for conducting some of the operations of the authorizing entity computer 110. That is, some of the operations typically conducted by the issuer computer during the enrollment and subsequent authentication of the user device 112, e.g., a user, may be shifted to the directory server computer 108. This provides an additional layer of security from a source trusted by the authorizing entity operating the authorizing entity computer 110. As such, additional validations/verifications and repeated attempts to authorize the payment transaction are not needed, thereby reducing network traffic.

Embodiments provide techniques for enabling merchants to submit FIDO authentication data in the messaging, while the directory server computer 108 (or the token service computer 312) may validate the authentication data submitted from the merchants in real time and provide a successful authentication output in both the 3DS and CTF transaction flows. Embodiments implement verification, e.g., attestation, of the FIDO authenticator used in the authentication of the user device (or the user) and a signature validation method to ensure that the payload submitted downstream for the transaction is in good standing. As such, the techniques disclosed herein provide an improved authentication method that utilizes a multiple verification/validation layers substantially improving, e.g., enhancing, the security of the computer networks. Because the disclosed techniques provide certain security guarantees (e.g., by performing exhaustive verifications of devices and validation of messaging), the issuer can trust the security of the disclosed techniques and can approve the transaction by simply looking up the previously generated verification data, e.g., the authentication cryptogram generated based on previously conducted assertion/authentication.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be generated using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a server computer, an authentication data packet comprising authentication data from a relying party computer in communication with an authenticator associated with a user device;
verifying, by the server computer, the authentication data in the authentication data packet;
storing, by the server computer, the authentication data packet in a database; and
transmitting, by the server computer to an authorizing entity computer, a data packet comprising data relating to the verification of the authentication data.

2. The method of claim 1, further comprising:
based on the verifying, obtaining, by the server computer, security data; and
transmitting the security data to the relying party computer.

3. The method of claim 2, further comprising:
receiving, by the server computer from the relying party computer, an authorization request message comprising the security data;
modifying the authorization request message to include the security data; and
transmitting, by the server computer, the modified authorization request message comprising the authentication data packet and the security data to the authorizing entity computer for authorization.

4. The method of claim 2, wherein the security data is an authentication cryptogram.

5. The method of claim 4, wherein the authentication cryptogram indicates a successful verification of the authentication data included in the authentication data packet, and
wherein the obtaining the security data further comprises:
receiving, by the server computer, the authentication cryptogram generated by the authorizing entity computer upon receiving the data relating to the verification of the authentication data, or generating, by the server computer, the authentication cryptogram based on the verification of the authentication data by the server computer.

6. The method of claim 1, wherein the authenticator has a public-private key pair associated therewith, and the authentication data comprises data signed by a private key of the public-private key pair.

7. The method of claim 6, wherein the authentication data further comprises an authentication time, a relying party identifier (ID), an authenticator ID, a user verification flag, and a user present flag.

8. The method of claim 7, further comprising:
prior to the receiving the authentication data packet, performing, by the server computer, an enrollment process by which the relying party computer and the authenticator facilitate an enrollment of the user device.

9. The method of claim 8, wherein the verifying comprises:
verifying whether a difference between the authentication time and an enrollment time is less than a threshold time period value;
verifying whether the relying party ID matches an origin relying party ID known to the server computer from the enrollment process;
verifying whether the authenticator ID is an authenticator attestation globally unique (AAGUID) known to the server computer from the enrollment process;
verifying whether the user verification flag is set to true, which is indicative of whether a user was successfully authenticated by the authenticator; and
verifying whether the user present flag is set to true, which is indicative of whether the user was present during authentication by the authenticator.

10. The method of claim 9, wherein the verifying further comprises determining that the verification of the authentication data is successful by:
determining that the difference between the authentication time and the enrollment time is less than the threshold time period value;
determining that the relying party ID matches the origin relying party ID known to the server computer from the enrollment process;
determining that the authenticator ID is the AAGUID known to the server computer from the enrollment process;
determining that the user verification flag is set to true that is indicative that the user was successfully authenticated by the authenticator; and
determining that the user present flag is set to true that is indicative that the user was present during the authentication by the authenticator, and
wherein the method further comprises obtaining, by the server computer, security data based on the determining that the verification of the authentication data is successful.

11. The method of claim 6, wherein the authentication data further comprises a client data including a hash algorithm and an authenticator data including a public key of the public-private key pair, and
the data that is signed by the private key is a digital signature that is obtained by signing, by the private key, a concatenated value that is a concatenation of the client data and the authenticator data.

12. The method of claim 11, wherein the verifying comprises verifying the digital signature using the public key.

13. The method of claim 1, wherein the server computer includes a directory server computer.

14. The method of claim 1, wherein the authenticator is a Fast Identity Online (FIDO) authenticator.

15. A server computer comprising:
a processor; and
a non-transitory computer-readable medium comprising code that, when executed by the processor, causes the processor to perform a method including:
receiving an authentication data packet comprising authentication data from a relying party computer in communication with an authenticator associated with a user device;
verifying the authentication data in the authentication data packet;
storing the authentication data packet in a database; and
transmitting, to an authorizing entity computer, a data packet comprising data relating to the verification of the authentication data.

16. A method comprising:
generating, by an authenticator associated with a user device, a public-private key pair;
authenticating, by the authenticator, a user of the user device;
generating, by the authenticator, a client data and an authenticator data, the authenticator data including an indication that the user has been authenticated by the authenticator;
generating, by the authenticator, an assertion signature by signing a concatenated value with a private key of the public-private key pair, wherein the concatenated value is formed by concatenating the client data and the authenticator data; and
sending, by the user device, a data packet including the client data, the authenticator data, and the assertion signature to a relying party computer,
wherein the relying party computer validates the assertion signature using the received client data and authenticator data and a public key of the public-private key pair, and, based at least on the assertion signature being validated, generates an authentication data packet comprising an authentication data, the authentication data including the assertion signature, the client data, and the authenticator data, and sends the authentication data packet to a server computer, and
wherein the server computer thereafter receives the authentication data packet, verifies the authentication data in the authentication data packet, stores the authentication data packet in a database, and transmits, to an authorizing entity computer, a data packet comprising data relating to the verification of the authentication data.

17. The method of claim 16, wherein the user device is a mobile phone.

18. The method of claim 16, wherein the authenticator is a Fast Identity Online (FIDO) authenticator.

19. The method of claim 16, further comprising:
storing the private key in a database within the authenticator; and
generating a credential identifier (ID) that contains information about a location of the private key in the database.

20. The method of claim 19, further comprising:
sending the public key and the credential ID to the relying party computer as a part of the authenticator data.
